(19) United States
(12) Patent Application Publication
(10) Pub. No.: US 2017/0358017 A1
(43) Pub. Date: Dec. 14, 2017

(54) PRICE BREAKS IN A CLOUD COMPUTING SYSTEM FOR USING AN AUTOMATIC SCHEDULER

(71) Applicant: GOOGLE INC., Mountain View, CA (US)

(72) Inventor: Gregory B. D'ALESANDRE, Mountain View, CA (US)

(73) Assignee: GOOGLE INC., Mountain View, CA (US)

(21) Appl. No.: 13/840,291

(22) Filed: Mar. 15, 2013

Related U.S. Application Data
(60) Provisional application No. 61/664,519, filed on Jun. 26, 2012.

(51) Int. Cl. G06Q 30/02

(52) U.S. Cl. CPC G06Q 30/0283

(57) ABSTRACT

Systems and methods and portions thereof are discussed pertaining to a method of adjusting a fee charged for use of a computing resource in a cloud computing environment by establishing a first pricing scheme for the computing resource; monitoring use of the computing resource by a user entity; determining, based on the monitoring, whether the user entity permits an automatic scheduler to make scheduling decisions for use of the computing resource without direction from the user entity; and establishing a second pricing scheme for the computing resource, where the second pricing scheme charges differently for use of the computing resource than the first pricing scheme such that one of the first and second pricing schemes charges less for computing resource usage responsive to a determination that the user entity permits the automatic scheduler to make scheduling decisions for use of the computing resource without direction from the user entity.

### PRIORITY

The present application claims benefit of priority under 35 U.S.C. §119(e) to U.S. Provisional Application No. 61/664,519, which was filed with the United States Patent and Trademark Office on Jun. 26, 2012, the entire contents of which are hereby incorporated by reference.

### BACKGROUND

Before the advent of cloud computing as a commercial service, distributed computing was almost entirely restricted to use within government agencies and scientific and educational institutions. Such organizations did not generally need to deal with issues such as portability, virtualization, and cross-platform operation on a large scale. Projects addressing such concerns were generally purpose-driven and involved a large amount of customization.

Now, virtualized computing resources are being sold commercially. With the advent of competing and, in some cases, conflicting virtualization platforms and infrastructures, tools and techniques for resource optimization and job scheduling are becoming directly linked to a financial cost for utilizing computing resources. In massively parallel, large-scale distributed computing environments, it may be preferable to optimize the system as a whole instead of allowing individuals to separately configure the operating parameters and resource allocation properties of their individual applications. However, in some cases the optimal configuration for the overall environment may be inconsistent with a perceived optimal configuration for a particular user. In such situations, it may be preferable to give the user a financial incentive to allow overall system optimization.

### SUMMARY

The techniques and solutions discussed herein relate to methods of adjusting a pricing scheme by which a user is charged for computing resources based on a level of control over job scheduling that a user has or surrenders. Because of overall improvements in system efficiencies that can be realized by fully automated (zero to minimal user control) job scheduling and app instance spin-up paradigms, it is advantageous to charge users less for allowing fully automated control, thereby encouraging users to cede resource allocation and scheduling control and allow the overall system to operate more efficiently. Particular embodiments relate to giving discounts for users who do not set a cap on a number of idle application instances. Other embodiment may relate to giving discounts for users who allow for automatic latency setting or who are otherwise willing to surrender control of latency settings.

Embodiments and techniques and devices described herein may pertain to a system, comprising: a processor; and a memory having instructions stored therein, said instructions causing the processor to execute a method of adjusting a fee charged for use of a computing resource in a cloud computing environment, the method comprising establishing a first pricing scheme for the computing resource; monitoring use of the computing resource by an application instance or job request associated with a user entity; determining whether the user entity permits an automatic scheduler to make resource allocation and scheduling decisions for use of the computing resource independent of instructions from the user entity; responsive to a determination that the user entity permits the automatic scheduler to make scheduling decisions for use of the computing resource independent of instructions from the user entity, establishing a second pricing scheme for the computing resource, where the second pricing scheme charges a different amount for use of the computing resource than the first pricing scheme; and calculating a usage charge for the monitored computing resource use based on the monitored use and at least one of the first and second pricing scheme.

In some embodiments, the computing resource includes a computing resource associated with an application instance; the step of monitoring use including detecting an instruction for tear-down of the application instance; and the step of establishing a second pricing scheme including not charging the user entity for computing resource use associated with tear-down of the application instance.

In some embodiments, the second pricing scheme represents a percentage discount of a time-based per-resource usage change as compared to the first pricing scheme.

In some embodiments, the method further comprises analyzing a parameter of the application instance or job request; and determining includes deciding, based on the analyzed parameter, whether the resource allocation and scheduling decisions for the monitored computing resource are made by the automatic scheduler independent of instructions from the user entity.

In some embodiments the parameter indicates a maximum number of idle application instances; and deciding includes deciding that the resource allocation and scheduling decisions for the monitored computing resource with respect to idle application instances are made by the automatic scheduler in response to a parameter value indicating a system default number of idle application instances.

In some embodiments, the parameter indicates a maximum acceptable latency time for job execution; and deciding includes deciding that the resource allocation and scheduling decisions for the monitored computing resource with respect to acceptable latency time are made by the automatic scheduler in response to a parameter value indicating a system default number for acceptable latency time.

In some embodiments, the parameter indicates a minimum number of active application instances; and deciding includes deciding that the resource allocation and scheduling decisions for the monitored computing resource with respect to total number of active application instances are made by the automatic scheduler in response to a parameter value indicating a system default number for minimum number of active application instances.

In some embodiments, the computing resource represents a virtual computing device; and monitoring use of the computing resource includes measuring an amount of time that the virtual computing device is dedicated to the application instance or job request.

In some embodiments the computing resource represents a discrete unit of data processing capability; and monitoring use of the computing resource including measuring an amount of data processed with the discrete unit of data processing capability by the application instance or job request.

In some embodiments, calculating a usage charge comprises: responsive to the determination that the user entity permits the automatic scheduler to make resource allocation and scheduling decisions for use of the computing resource independent of instructions from the user entity, calculating a usage charge based on the monitored use and the second pricing scheme; responsive to the determination that the user entity does not permit the automatic scheduler to make resource allocation and scheduling decisions for use of the computing resource independent of instructions from the user entity, calculating a usage charge based on the monitored use and the first pricing scheme; and the method further comprising causing an account associated with the user entity to be charged the calculated usage charge.

Further embodiments may pertain to a non-transitory computer-readable medium having embodied thereon instructions which, when executed by a processor, cause the processor to carry out some or all of the method steps described above. Further embodiments still may pertain to methods including some or all of the method steps described above and realized in various combinations of hardware and software implementation.

Further scope of applicability of the systems and methods discussed herein will become apparent from the detailed description given hereinafter. However, it should be understood that the detailed description and specific examples, while indicating preferred embodiments of the systems and methods, are given by way of illustration only, since various changes and modifications within the spirit and scope of the concepts disclosed herein will become apparent to those skilled in the art from this detailed description.

### BRIEF DESCRIPTION OF THE DRAWINGS

The systems and methods discussed will become more fully understood from the detailed description given herein below and the accompanying drawings which are given by way of illustration only, and thus are not limitative, and wherein

FIG. 1a depicts an embodiment of a cloud computing environment as described herein;

FIG. 1b depicts an embodiment of a datacenter as described herein;

FIG. 1c depicts an embodiment of a computing device as described herein;

FIG. 2a depicts an embodiment of a schedule-based pricing scheme as described herein

FIG. 2b depicts an embodiment of a schedule-based pricing scheme as described herein;

FIG. 2c depicts an embodiment of a schedule-based pricing scheme as described herein; and

FIG. 3 depicts an embodiment of a schedule-based pricing scheme as described herein.

The drawings will be described in detail in the course of the detailed description.

### DETAILED DESCRIPTION

The following detailed description refers to the accompanying drawings. The same reference numbers in different drawings identify the same or similar elements. Also, the following detailed description does not limit the concepts discussed. Instead, the scope of the concepts discussed herein is defined by the appended claims and equivalents thereof.

In a commercial cloud computing environment, computing resources are made available to users based on things like service level agreements and pricing schedules. Depending on the amount of computing resources (processing, memory, storage, etc.) that a user wishes to have, they may be charged a certain amount. Users may be charged for having a pool of resources available to draw on, and/or may be charged for actual resource consumption. In some embodiments, a cloud computing environment may have an automatic scheduler that schedules jobs and/or allocates resources. Such automatic resource allocation and job scheduling may be based on a desired performance level for an application, a maximum spending amount for an application in a given time period, optimization of resource usage and availability across the cloud computing environment, and/or job and resource access or execution priority related to service level agreements (SLAs) and/or subscription or pricing levels associated with the entities requesting or requiring the jobs or resources.

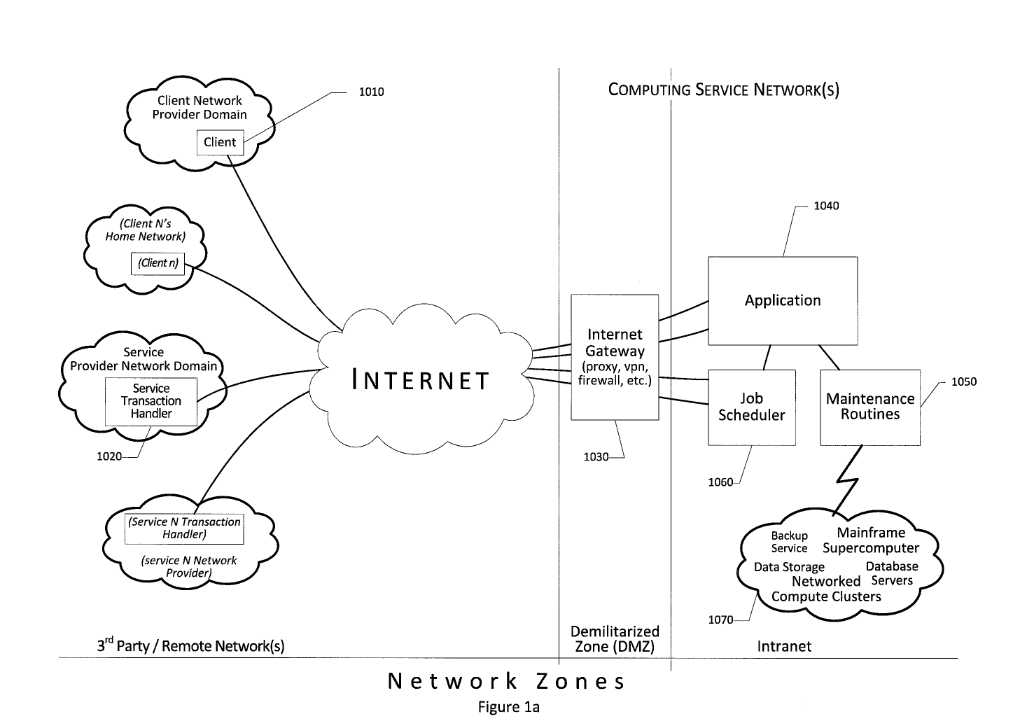

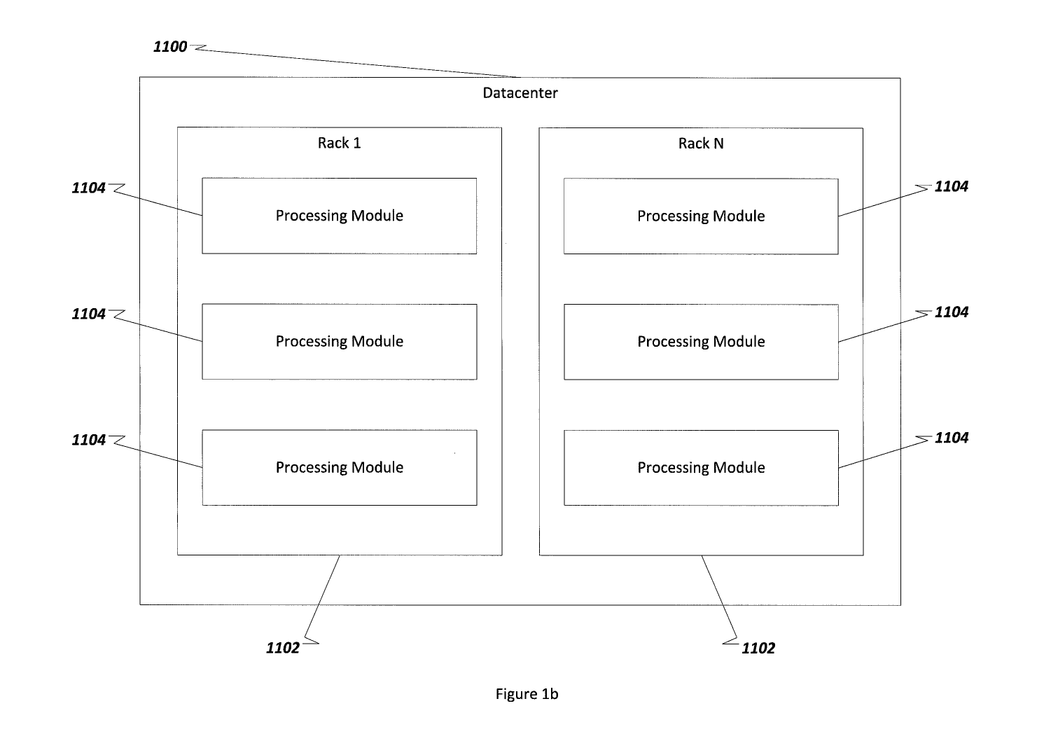

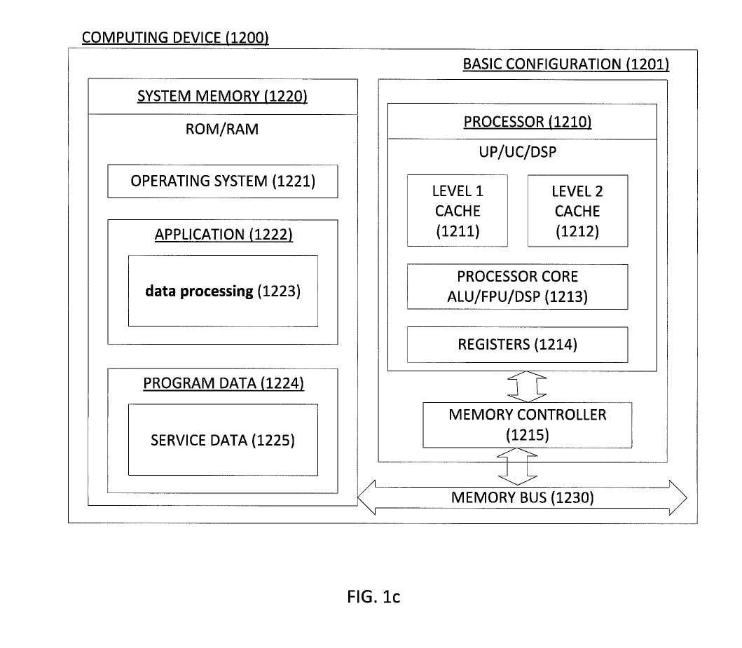

In one embodiment of a cloud computing environment, an application may be hosted or otherwise managed in the manner shown in FIG. 1a. In the figure shown, the application 1040 may reside on a computing service network such as, for example, a cloud computing environment. Supporting features, such as data storage, back-ups, maintenance features, and payment and authentication interfaces may reside on one or more sub-systems 1050 within the cloud computing environment. Such sub-systems 1050 may be separate applications, part of the application 1040, or may be part of the overall cloud computing infrastructure and not tied to a particular application. Such sub-systems may include services or features such as transaction handlers, database connections, back-up and maintenance features 1070.

A job and/or resource scheduler 1060 may also be included in the cloud computing environment. The scheduler 1060 may be part of the cloud computing infrastructure or may be a separate module/application. In some embodiments, an application 1040 may communicate directly with the job scheduler 1060. In further embodiments, the job scheduler 1060 may be directly accessible/available to users wishing to submit jobs or allocate resources to applications. In some embodiments, automatic job or resource allocation and scheduling may be a parameter set within or for an application 1040. In other embodiments, where a scheduler 1060 or scheduler interface is available for direct access, individual job or resource requests may be flagged for automated resource allocation and scheduling on an individual or aggregated basis. In further embodiments, an application 1040 may have a job and/or resource queue that acts as a scheduler interface, and items in that queue may be flagged for automated resource allocation and scheduling.

In further embodiments, the automated resource allocation and scheduling aspect may be de-activated or otherwise “turned off” for some or all instances of a particular application. In such embodiments, an application 1040 may be configured to always operate at some minimum (or maximum) resource level and/or number of instances, with the scheduler 1060 managing changes in instance numbers and/or resource usage up to or down to the specified maximum/minimum.

In embodiments of cloud computing environments where authentication services may be offered as part of the cloud infrastructure, a connecting entity, such as a client 1010, may initiate and conduct communications with a provisioned communication gateway 1030 via a network or internet connection as an initial step in accessing an application 1040. Embodiments of such provisioning may, for purposes of facilitating a secure computing environment and discreet handling of data, enforce encryption of communication channels using strong authentication mechanisms, compartmentalized handling, processing, and storage of data, as well as exhaustive application of system hardening techniques that include documented, routine maintenance of system and application patches, monitored and access-restricted ingress and egress network ports and services, and lastly routine reviews of system and security logs.

In some embodiments, the gateway 1030 may be in a demilitarized zone (DMZ) between the internet and the application 1040. The application 1040 may reside on a module, set of modules, server, or set of servers that runs and provides the application via the distributed computing environment. The overall cloud computing environment may also reside behind the DMZ. In the embodiment shown, the client 1010, which may be one of any number of clients (existing on any number of separate client networks), connects to the application 1040 via the gateway 1030. At or shortly after connection, the application 1040 or an authentication service associated with the application or with the cloud computing environment, recognizes the client 1010 and looks at any additional information related to the client, such as financial data or remote profile information. Such additional information may be accessed or provided either within the cloud computing environment or, in embodiments using certain forms of external financial data such as credit card payment information, via an external service transaction handler 1020. In some embodiments, multiple external service transaction handlers may reside on one or more service provider domain networks.

The service transaction handler 1020 may be a complete transaction processing system or may interface with one or more remote or separate service providers to exchange data. Such an embodiment may be preferred for payment solutions where clients may wish to use credit card or debit card payment schemes. In some embodiments, the service transaction handler(s) 1020 may also track system resource usage of the application. Such tracking may be used for tracking client usage and/or for overall cloud computing resource usage by the application 1040 as, for instance, application instances are spun up or torn down. In some embodiments, the service transaction handler 1020 may reside in the intranet along with the application 1040 and resource scheduler 1060. In further embodiments, the resource/job scheduler 1060 may communicate with a financial service transaction handler to provide information on resource usage or job execution. Such information may, in some embodiments, include data indicating a pricing level or discount level associated with a resource allocation or job execution task based on a scheduling or allocation scheme used by the scheduler 1060.

The pricing information may be tracked in a usage or history log that may be stored in one or more databases or other data storage solutions for subsequent access and/or analysis. In some embodiments, pricing information indicating a pricing level or discount level may be generated by the scheduler and transmitted as part of a web-based information request such as a query or an HTTP or HTTPS request. In some embodiments, users or clients may be required to have an existing balance deposited in or associated with an account on the system performing the job execution. In other embodiments, users or clients may directly link a bank account or credit cart to their account on the system performing the job execution, allowing charges to be periodically assessed either at scheduled intervals or as they accrue. In some such embodiments, discounts realized as a result of using an automated scheduler 1060 may be posted as credits back to the bank or credit card account.

In some embodiments, the DMZ may include an authentication mechanism for authenticating users and, in some embodiments, generating a session token. In some embodiments, the transaction handler may be part of an overall transaction management solution used across a range of services, including payment for computing resources. The application 1040 and, in some embodiments, any associated sub-systems 1050, as well as environment or infrastructure components (such as, for instance, a scheduler 1060) may reside in one or more data centers of the type shown in FIG. 1b.

FIG. 1b is a block diagram illustrating an example of a datacenter 1100. The data center 1100 is used to store data, perform computational tasks, and transmit data to other systems outside of the datacenter using, for example, a network connected to the datacenter. In particular, the datacenter 1100 may perform large-scale data processing on massive amounts of data.

The datacenter 1100 includes multiple racks 1100. While only two racks are shown, the datacenter 1100 may have many more racks. Each rack 1100 can include a frame or cabinet into which components, such as processing modules 1104, are mounted. In general, each processing module 1104 can include a circuit board, such as a motherboard, on which a variety of computer-related components are mounted to perform data processing. The processing modules 1100 within each rack 1100 are interconnected to one another through, for example, a rack switch, and the racks 1100 within each datacenter 1100 are also interconnected through, for example, a datacenter switch.

In some implementations, the processing modules 1100 may each take on a role as a master or worker. The master modules control scheduling and data distribution tasks among themselves and the workers. A rack can include storage, like one or more network attached disks, that is shared by the one or more processing modules 1100 and/or each processing module 1104 may include its own storage. Additionally, or alternatively, there may be remote storage connected to the racks through a network.

The datacenter 1100 may include dedicated optical links or other dedicated communication channels, as well as supporting hardware, such as modems, bridges, routers, switches, wireless antennas and towers. The datacenter 1100 may include one or more wide area networks (WANs) as well as multiple local area networks (LANs).

In some embodiments, an application 1040 may include one or more processing modules 1104 or even one or more racks of modules 1102 depending on the complexity and level of computing resources required for the application 1040 and/or instances thereof. The application itself 1040 may behave, with respect to the rest of the cloud computing environment, as a logical computing device. This logical computing device may be physically embodied by one or more (or, in some cases, by less than one) processing modules 1104 of the data center, each of which may itself be a physical computing device.

FIG. 1c is a block diagram illustrating an example computing device 1200 that is arranged for parallel processing of data and may be used for one or more of the processing modules 1104. In a very basic configuration 1201, the computing device 1200 typically includes one or more processors 1210 and system memory 1220. A memory bus 1230 can be used for communicating between the processor 1210 and the system memory 1220.

Depending on the desired configuration, the processor 1210 can be of any type including but not limited to a microprocessor (μP), a microcontroller (μC), a digital signal processor (DSP), or any combination thereof. The processor 1210 can include one more levels of caching, such as a level one cache 1211 and a level two cache 1212, a processor core 1213, and registers 1214. The processor core 1213 can include an arithmetic logic unit (ALU), a floating point unit (FPU), a digital signal processing core (DSP Core), or any combination thereof. A memory controller 1216) can also be used with the processor 1210, or in some implementations the memory controller 1215 can be an internal part of the processor 1210.

Depending on the desired configuration, the system memory 1220 can be of any type including but not limited to volatile memory 1204 (such as RAM), non-volatile memory 1203 (such as ROM, flash memory, etc.) or any combination thereof. System memory 1220 typically includes an operating system 1221, one or more applications 1222, and program data 1224. The application 1222 may include capabilities for large-scale data processing 1223 using techniques such as parallel processing. Program Data 1224 includes storing instructions that, when executed by the one or more processing devices, implement a set of processes to perform some or all of the application steps or operations. In some embodiments, the application 1222 can be arranged to operate with program data 1224 on an operating system 1221.

The computing device 1200 can have additional features or functionality, and additional interfaces to facilitate communications between the basic configuration 1201 and any required devices and interfaces.

System memory 1220 is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media can be part of the device 1200.

The computing device 1200 can be implemented as a portion of a small-form factor portable (or mobile) electronic device such as a cell phone, a personal data assistant (PDA), a personal media player device, a wireless web-watch device, a personal headset device, an application-specific device, or a hybrid device that include any of the above functions. The computing device 1200 can also be implemented as a personal computer including both laptop computer and non-laptop computer configurations.

The parameters, configuration, and settings of a set of resources associated with the application 1040 may also be represented at least in part as a basic configuration 1201 of a computing device 1200. Such a virtual computing device has no specific physical structure, but may instead be represented by resources allocated from part, all, or several physical computing devices 1200 included in a data center 1100. Similarly, jobs submitted to, for, or by an application 1040 may have associated resource allocations, memory requirement, and processing times represented by resources allocated or required from art, all, or several computing devices. In embodiments where resources and jobs may be scheduled or allocated either on a schedule or scheme set by an application/application owner or automatically by an automated resource/job scheduler available as part of the cloud computing infrastructure, charges associated with the allocated/scheduled resources may vary depending on the scheduling scheme used to perform the allocation.

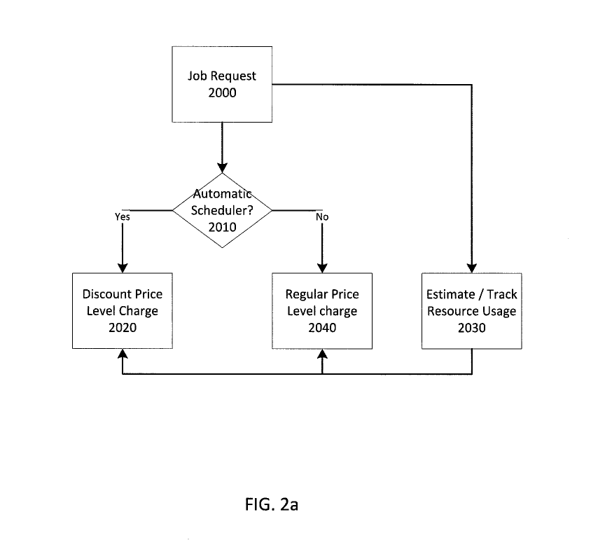

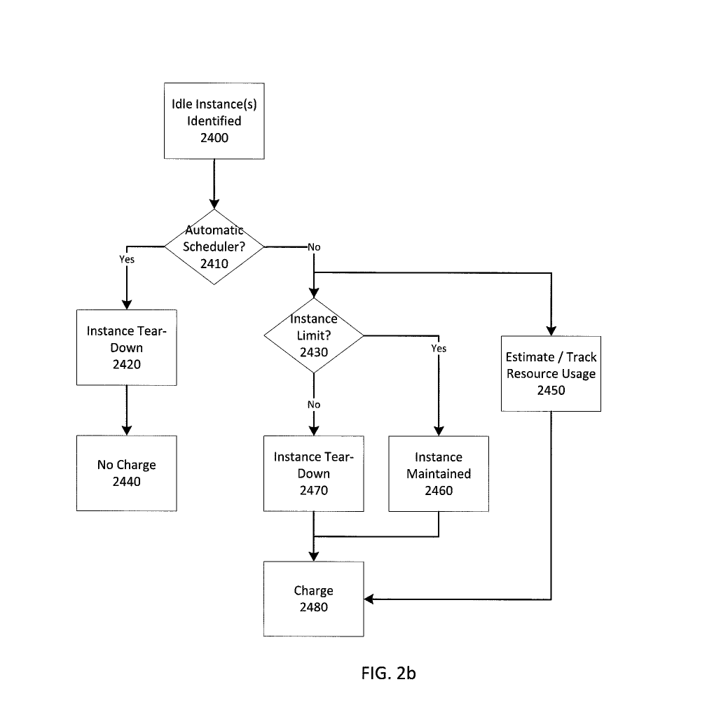

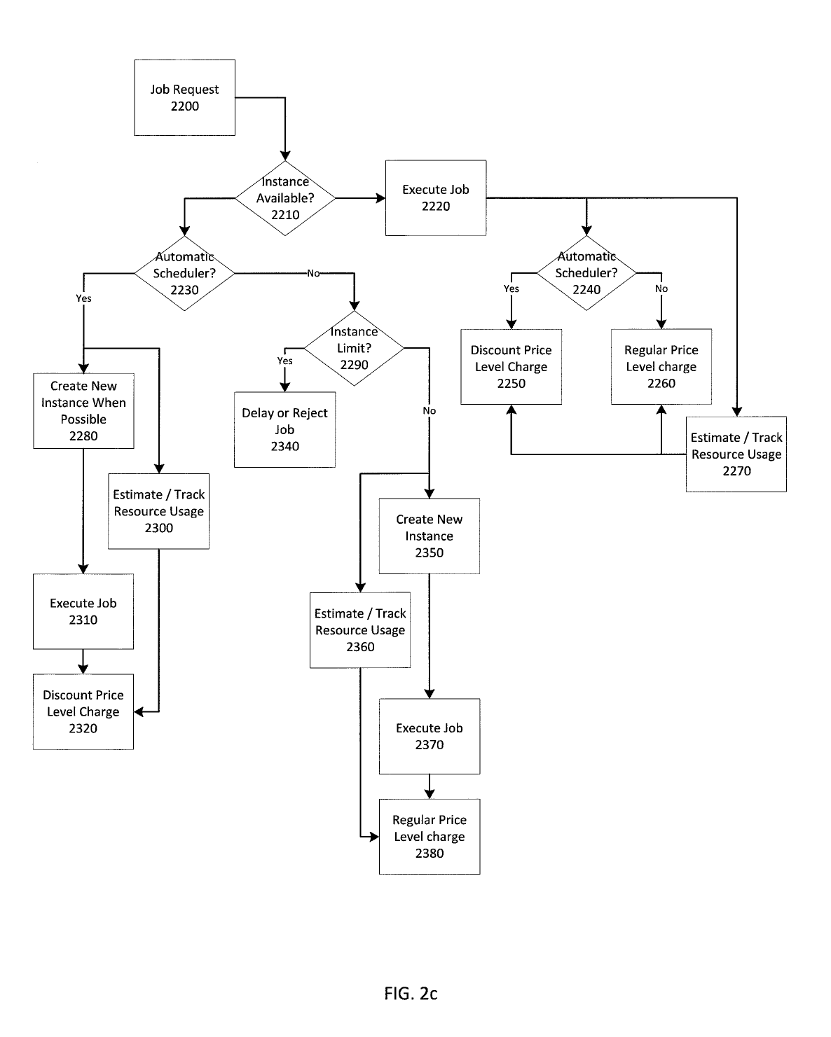

FIG. 2a depicts an embodiment of a job scheduling and resource allocation scheme whereby an individual job request may be submitted or identified for processing 2000. In such an embodiment the job request may be submitted as either one to be managed by an automatic scheduler or one with specific scheduling and execution parameters/Regardless of the chosen scheduling scheme, the resource consumption of the job (e.g. memory and processor usage) may be estimated or tracked 2030. In some embodiments, the estimation and tracking of usage 2030 may also include a measure of overall system load. Such measures may, in some cases, include a resource scarcity indicator or a signal indicating sub-optimal resource allocation.

The scheduling status of a job may be checked/evaluated 2010 to determine an appropriate pricing scheme. In some embodiments, a job that is managed through the automated resource allocation and scheduling tool(s)/capabilities of the cloud computing environment may be afforded a discount price level 2020 whereas a job that is submitted or otherwise executed based on user-defined or otherwise externally provided scheduling or resource allocation parameters may not be afforded such a discount 2040. The appropriate price level or discount indicator may then be combined with the tracked or estimated resource usage level 2030 to determine an overall price for the job and/or resources allocated to the job.

In some embodiments, such a price-to-schedule connection may be realized by setting a particular parameter in the job/job request 2000 indicating that it is either is or is not to be handled by the automatic scheduler 2010. Examples of such a parameter may include a latency setting indicating an expected minimum or maximum time between job request submission and execution. In other embodiments, the automatic scheduler and/or built-in scheduling capabilities of the system performing job execution may be a default setting or parameter that must be expressly overridden or changed either on a per-user or per-job basis. Such a parameter may, when identified or otherwise detected 2010 in the job/job request 2000, cause a price or cost calculation aspect of the system to add a price premium or disable an otherwise applied discount to the calculated price 2020 of the job.

In some embodiments, such a discount or premium may be a complete or partial percentage of the calculated or expected price, a fixed/set cost amount, or some combination or embodiment thereof. In some embodiments, there may be a fixed price associated with disabling or otherwise opting out of the automated scheduler for a particular time period or set of jobs or applications, and/or a percentage price increase applied on a per-job/per-request basis.

After being calculated, the cost may be charged to an account registered on the cloud computing environment. In some embodiments, the cost may be directly passed to a financial transaction handler associated with a credit card or other payment scheme connected to the account or the job request.

In some embodiments, a job request 2000 may include or cause another application instance to be created. In other embodiments, the job request 2000 may in fact be a tear-down or application instance removal process. In some such embodiments, the concept of charging for instance tear-down or removal may not be applicable. In other embodiments, an instance removal or tear-down request coming from an automated scheduler may have no cost associated therewith whereas an instance removal or tear-down request triggered by application-specific or instance-specific parameters of the application or application instance may incur a resource cost for the computing time and memory required to tear the application or application instance down.

In one such embodiment, shown in FIG. 2b, the “discount” afforded by the automated scheduler may include free removal or tear-down of application instances in response to a tear-down request instead of causing an application or application instance to incur a removal or tear-down charge or ongoing maintenance costs for an idle application instance. In the embodiment shown, when one or more idle or excess application instances are identified 2400, a check may be performed to see if they are application instances being managed by the automatic scheduler 2410. If the instances are being managed by the automatic scheduler, the excess or idle instances may be torn down 2420 and the user account associated with those application instances will not be charged 2440 for the tear-down or for any maintenance costs incurred on the idle instances as part of instance tear down.

If the instances are not being managed by the automatic scheduler, another check may be performed to determine if there is a minimum number of required instances 2430 set for the application. In some embodiments, this may be a total minimum number of required instances. In such embodiments, if a total number of application instances (including the detected idle instances) meets the minimum number of required instances, all the application instances are maintained 2460 and the user is charged accordingly 2480 based on resource usage 2450. In other embodiments, this may be a maximum number of permitted idle application instances 2430. In such embodiments, if the number of identified idle instances 2400 is less than (or, in some embodiments, equal to) the permitted number of idle instances, all the application instances are maintained 2460 and the user is charged accordingly 2480.

If there are more than a minimum number of required instances or more than a permitted number of idle application instances, the excess idle application instance(s) may be torn down 2470. However, because such a tear-down is not managed or otherwise overseen by the automatic scheduler, the user account may still be charged 2480 based on resource usage 2450 associated with the tear-down or otherwise incurred as part of the process of instance tear-down 2470.

In some embodiments, automatic job and resource scheduling may be set as an application-wide parameter. Examples of such a parameter may include latency settings, maximum idle application instances, minimum number of active application instances, and other parameters related to a number of application instances and expected responsiveness thereof. In some embodiments, such parameters may be represented as a set of values including a value recognized as a system default setting. For example, a setting of “−1” for a minimum number of active application instances may indicate that control over this parameter is relegated to the automatic scheduler.

In such embodiments, all job requests from the application may be handled via an automatic scheduler. In such embodiments, an overall price discount amount or level may be applied to the application based on such a parameter setting. In such embodiments, an automatic scheduling parameter or signal may be included with each job or resource request originated by the application, including requests for additional application instances. One embodiment of such a scheme is shown in FIG. 2c.

In the embodiment shown in FIG. 2c, when a job request is received 2200, the system may first attempt to determine if there is an application instance available to service the job request 2210. If an application instance is available, the job is executed 2220 and the as either one to be managed by an automatic scheduler or one with specific scheduling and execution parameters 2240. Regardless of the chosen scheduling scheme, the resource consumption of the job (e.g. memory and processor usage) may be estimated or tracked 2270. An appropriate pricing scheme 2250, 2260 may then be applied to the tracked or estimated resource usage 2270 based on whether the job or application instance executing the job is managed by the automatic scheduler or not 2240.

If an application instance is not available to execute the received job 2200, a check may be performed to determine whether the application or application instance(s) currently active are being managed by the automatic scheduler 2230. An application instance may not be available because of reasons which may include insufficient application instances, excess usage load, or overly high expected latency times. If the application and/or instance(s) are managed by the automatic scheduler, a new application instance may be created at the discretion of the scheduler 2280 and the job executed 2310 on the new instance. Resource usage of the new instance may be tracked/estimated 2300 with a discounted/lower pricing scheme being applied to the job execution 2310 based on the tracked resource usage 2300. In other embodiments, if an expected latency level is within a timeframe when an application instance is expected to become available, the job may simply be executed 2220 at the control of the automated scheduler without creating a new application instance.

If the application and/or instance(s) are not managed by the automatic scheduler, a further check may be performed to determine if the number of allowed application instances is capped or limited and whether the number of current application instances is at that cap or limit 2290. If the cap or limit on instances has been reached, the job request may be delayed or rejected outright depending on factors such as expected latency or overall system load 2340. Otherwise, a new application instance may be created 2350 and the job executed 2370 on the new instance. Resource usage of the new instance may be tracked/estimated 2360 with a normal, non-discounted, or even increased pricing scheme being applied to the job execution 2370 based on the tracked resource usage 2360. In other embodiments, if an expected latency level is within a timeframe when an application instance is expected to become available, the job may simply be executed 2220 without creating a new application instance and a charge computed 2260 accordingly.

In some embodiments, an instance limit 2290 may also include or be replaced with an expected latency level check. In such embodiments, a number of application instances may be governed by a minimum or maximum or average expected latency setting that determines an acceptable or desirable level of delay between accepting a job request 2200 and producing an output from the request execution. Applications or application instances using an automated scheduler may also be subject to automatic latency setting, with the system deciding on or otherwise controlling expected or acceptable levels of delay.

In some embodiments, application instances may be individually configured to either use the automated resource allocation/job scheduling capabilities of the cloud computing environment or to perform resource allocation/job execution based on application-specific parameters that override some or all of the automated scheduler.

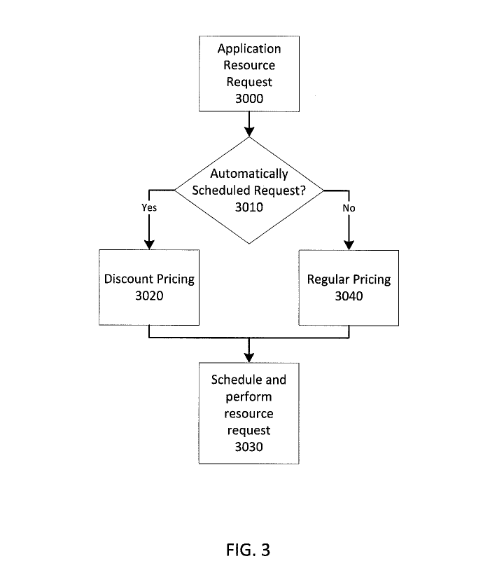

In such embodiments, as shown in FIG. 3, an application resource request 3000 may be evaluated to determine whether it is originated by an application instance managed by the automated resource scheduler 3010. For those requests originated from an application instance managed by the automated resource/job scheduler, a discount pricing scheme such as a reduced usage rate or a percentage discount may be applied or indicated for the request 3020. For those requests originated from an application instance having an alternate resource allocation and job scheduling scheme, such discounts may not be applied or offered 3040. The request, after having an appropriate pricing scheme indicator applied thereto, may then be carried out 3030.

In some cases, little distinction remains between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Only exemplary embodiments of the systems and solutions discussed herein are shown and described in the present disclosure. It is to be understood that the systems and solutions discussed herein are capable of use in various other combinations and environments and are capable of changes or modifications within the scope of the concepts as expressed herein. Some embodiments may be embodied in combinations of hardware, firmware, and/or software. Some embodiments may be embodied at least in part on non-transitory computer-readable storage media such as memory chips, hard drives, flash memory, optical storage media, or as fully or partially compiled programs suitable for transmission to/download by/installation on various hardware devices and/or combinations/collections of hardware devices. Such embodiments are not to be regarded as departure from the spirit and scope of the systems and solutions discussed herein, and all such modifications as would be obvious to one skilled in the art are intended to be included within the scope of the following claims:

1. A system, comprising:
a processor; and
a memory having instructions stored therein, said instructions causing the processor to execute a method allocating computing resources in a cloud computing environment, the method comprising:
receiving a resource request for use of the computing resources by an application instance or job request associated with a user entity;
determining that the user entity permits an automatic scheduler to make resource allocation and scheduling decisions for use of the computing resources;
flagging individual jobs associated with the resource request within a queue for automated resource allocation and scheduling in response to the determining that the user entity permits an automatic scheduler to make resource allocation and scheduling decisions;
determining that no application instances are available to service the resource request; and
causing a new application instance to be created to execute the resource request in response to the determining that the user entity permits the automatic scheduler to make the resource allocation and scheduling decisions and the determining that no other application instances are available to service the resource request.

2. The system of claim 1, the computing resources including a computing resource associated with a particular application instance;
wherein the received request includes an instruction for tear-down of the particular application instance.

3. (canceled)

4. The system of claim 1, the method further comprising analyzing a parameter of the application instance or job request;
wherein the determining that the user entity permits an automatic scheduler to make resource allocation and scheduling decisions for use of the computing resources comprises deciding, based on the analyzed parameter, that the resource allocation and scheduling decisions for the computing resource are made by the automatic scheduler independent of instructions from the user entity.

5. The system of claim 4, where the parameter indicates a maximum number of idle application instances; and
the deciding comprises deciding that the resource allocation and scheduling decisions for the computing resource with respect to idle application instances are made by the automatic scheduler in response to a parameter value indicating a system default number of idle application instances.

6. The system of claim 4, where the parameter indicates a maximum acceptable latency time for job execution; and
the deciding comprises deciding that the resource allocation and scheduling decisions for the computing resource with respect to acceptable latency time are made by the automatic scheduler in response to a parameter value indicating a system default number for acceptable latency time.

7. The system of claim 4, where the parameter indicates a minimum number of active application instances; and
the deciding comprises deciding that the resource allocation and scheduling decisions for the computing resource with respect to total number of active application instances are made by the automatic scheduler in response to a parameter value indicating a system default number for minimum number of active application instances.

8. The system of claim 1, where the computing resource represents a virtual computing device, and further comprising:
measuring an amount of time that the virtual computing device is dedicated to the application instance or job request.

9. The system of claim 1, where the computing resource represents a discrete unit of data processing capability, and further comprising
measuring an amount of data processed with the discrete unit of data processing capability by the application instance or job request.

10. (canceled)

11. A non-transitory computer-readable medium having embodied thereon instructions which, when executed by a processor, cause the processor to carry out a method of allocating use of a computing resource in a cloud computing environment, the method comprising
receiving a resource request for use of the computing resources by an application instance or job request associated with a user entity;
determining that the user entity permits an automatic scheduler to make resource allocation and scheduling decisions for use of the computing resource independent of instructions from the user entity;
flagging individual jobs associated with the resource request within a queue for automated resource allocation and scheduling in response to the determining that the user entity permits an automatic scheduler to make resource allocation and scheduling decisions;
determining that no application instances are available to service the resource request; and
causing a new application instance to be created to execute the resource request in response to the determining that the user entity permits the automatic scheduler to make the resource allocation and scheduling decisions and the determining that no other application instances are available to service the resource request.

12. The medium of claim 11, the computing resource including a computing resource associated with a particular application instance;
wherein the received request includes an instruction for tear-down of the particular application instance.

13. (canceled)

14. The medium of claim 11, the method further comprising analyzing a parameter of the application instance or job request; and
wherein the determining that the user entity permits an automatic scheduler to make resource allocation and scheduling decisions for use of the computing resources comprises deciding, based on the analyzed parameter, that the resource allocation and scheduling decisions for the computing resource are made by the automatic scheduler independent of instructions from the user entity.

15. The medium of claim 14, where the parameter indicates a maximum number of idle application instances; and
the deciding comprises deciding that the resource allocation and scheduling decisions for the computing resource with respect to idle application instances are made by the automatic scheduler in response to a parameter value indicating a system default number of idle application instances.

16. The medium of claim 14, where the parameter indicates a maximum acceptable latency time for job execution; and
the deciding comprises deciding that the resource allocation and scheduling decisions for the computing resource with respect to acceptable latency time are made by the automatic scheduler in response to a parameter value indicating a system default number for acceptable latency time.

17. The medium of claim 14, where the parameter indicates a minimum number of active application instances; and
the deciding comprises deciding that the resource allocation and scheduling decisions for the computing resource with respect to total number of active application instances are made by the automatic scheduler in response to a parameter value indicating a system default number for minimum number of active application instances.

18. The medium of claim 11, where the computing resource represents a virtual computing device, and the method further comprising:
measuring an amount of time that the virtual computing device is dedicated to the application instance or job request.

19. The medium of claim 11, where the computing resource represents a discrete unit of data processing capability, and the method further comprising:
measuring an amount of data processed with the discrete unit of data processing capability by the application instance or job request.

20. (canceled)

21. The method of claim 1, further comprising:
applying a first set of information to the individual jobs associated with the resource request when the individual jobs are flagged;
applying a second set of information, different from the first set of information, to the individual jobs associated with the resource request when the individual jobs are not flagged; and
providing an output of the first or second set of information applied to the computing resource.

22. The method of claim 21, wherein the first set of information comprises a first pricing scheme and the second set of information comprises a second pricing scheme.

23. The method of claim 1, wherein a default setting for the application instance from which the resource request was made permits the automatic scheduler to make resource allocation and scheduling decisions.

24. The method of claim 1, wherein the resource allocation and scheduling decisions determine a latency associated with executing the resource request.
